(19) United States
(12) Patent Application Publication
(10) Pub. No.: US 2024/0210237 A1
(43) Pub. Date: Jun. 27, 2024

(54) DETECTING OR PREDICTING CRITICAL HEAT FLUX IN COOLING SYSTEMS DURING POOL BOILING IN A NON-INTRUSIVE MANNER

(71) Applicant: BOARD OF TRUSTEES OF THE UNIVERSITY OF ARKANSAS, Little Rock, AR (US)

(72) Inventors: Han Hu, Fayetteville, AR (US); Christy Dunlap, Fayetteville, AR (US); Hari Pandey, Fayetteville, AR (US); Jackson Marsh, Fayetteville, AR (US); Ethan Weems, Fayetteville, AR (US)

(73) Assignee: BOARD OF TRUSTEES OF THE UNIVERSITY OF ARKANSAS, Little Rock, AR (US)

(21) Appl. No.: 18/544,086

(22) Filed: Dec. 18, 2023

Related U.S. Application Data
(60) Provisional application No. 63/434,137, filed on Dec. 21, 2022.

(51) Int. Cl. G01H 3/08

(52) U.S. Cl. CPC G01H 3/08

(57) ABSTRACT

A computer-implemented method, system, and computer program product for detecting or predicting the occurrence of critical heat flux in cooling systems. A model is built and trained to detect or predict the occurrence of critical heat flux in a cooling system based on acoustic data and/or image data. Such a model may be utilized to detect or predict the occurrence of critical heat flux in a cooling system by converting acoustic signals received from sensors remotely located from the cooling system from the temporal domain to a frequency domain. Furthermore, such a model may be utilized to detect or predict the occurrence of critical heat flux in a cooling system by extracting features from image data and acoustic data obtained from sensors remotely located from the cooling system and then concatenating such features.

### TECHNICAL FIELD

The present invention relates generally to cooling systems, such as two-phase cooling systems, and more particularly to detecting or predicting critical heat flux in cooling systems during pool boiling in a non-intrusive manner.

### BACKGROUND

A cooling system is utilized to remove and dissipate heat, such as from high-power heat sources, such as high-power density transformers, inverters, converters, batteries, power electronics, etc. Such cooling system may implement single-phase cooling, which may involve pumping liquid coolant through a cold plate which is attached to the heat source being cooled. The temperature of the liquid coolant increases as it passes through the cold plate, absorbing and storing the heat in its sensible heat capacity. Single-phase cooling is commonly used today in automotive systems and power electronic equipment.

Cooling systems may also implement two-phase cooling, which is generally used to remove and dissipate heat from high-power heat sources, such as electronics and lasers, or when the thermal energy needs to be transferred a significant distance between the heat source and the heat sink.

In two-phase cooling systems, heat may be transferred by the evaporation and condensation of a portion or all of the working fluid. Typically, a liquid near saturation is pumped into the cold plate, where it starts to boil, cooling the electronics and storing the energy in the latent heat of the fluid. The two-phase (liquid and vapor) fluid then flows to the condenser, where the heat is removed, condensing the vapor, so that a single-phase (liquid) exits the condenser, and the cycle repeats.

Such two-phase cooling systems correspond to thermal management systems that provide thermal management of power electronics. The rapid growth of electronic power output necessitates improved thermal management systems. Heat dissipation performance is essential to keep up with high power density applications, such as the subsystems within electric vehicles or data centers. Nucleate boiling (type of boiling that takes place when the surface temperature is hotter than the saturated fluid temperature by a certain amount but where the heat flux is below the critical heat flux) heat transfer accommodates this pursuit while maintaining a relatively low superheat by taking advantage of the high latent heat of the working fluid and efficient vapor removal. Nevertheless, nucleate boiling is bounded by a practical limit known as the critical heat flux, beyond which the heat transfer mode changes to an unstable and far less efficient transition boiling regime. A large fraction of the heater surface will be covered by a vapor film, causing significant heat transfer coefficient deterioration and potential device failures. As a result, heat flux needs to be monitored and regulated in boiling-based thermal management systems.

A variety of heat flux quantification methods have been implemented during pool boiling (vaporization that takes place at a solid surface submerged in a quiescent liquid), including the Joule effect method, the gradient method, and the transverse thermoelectric effect method, among others. The Joule effect method directly calculates the heat flux using the electrical voltage and current applied to the heating element and applies to systems with a large boiling surface area to total surface area ratio, e.g., boiling systems using thin-film heaters (e.g., indium tin oxide (ITO), titanium, and gold). Nevertheless, this method may be subject to large errors for non-uniform heating due to heat loss by spreading in the heater. The electrical power input is more commonly used as a reference to estimate the heat loss rather than directly calculate the boiling heat flux.

The gradient method measures the temperature difference across a layer of material with known thermal conductivity (k) and thickness to determine the temperature gradient at the boiling surface (∇T) and calculates the heat flux using Fourier's law (q=−k∇T). The response time of this approach is limited by thermal diffusion. A linear temperature profile will be obtained under steady-state conditions, which ensures accurate heat flux measurements with high sensitivities. Under transient conditions, inverse modeling of heat conduction with multiple temperature sensors will be required to account for the temporal and spatial nonlinearities.

The transverse thermoelectric effect method leverages materials with anisotropic thermal conductivity, electrical resistance, and thermoelectric coefficient to generate electric fields with a transverse component when heat passes through the principal axes of the materials. This approach allows for ultra-fast response and is thus suitable for transient heat flux measurements. Nevertheless, both the gradient method and the transverse thermoelectric effect method are implemented as contact, surface-mounted sensors, which can be intrusive to boiling and may produce challenges with sensor replacements.

Consequently, there is not currently an effective means for effectively detecting or predicting critical heat flux in cooling systems (thermal management systems) during pool boiling in a non-intrusive manner.

### SUMMARY

In one embodiment of the present disclosure, a computer-implemented method for detecting or predicting critical heat flux in cooling systems comprises building and training a model to detect or predict an occurrence of critical heat flux in a cooling system based on acoustic signals in a frequency domain. The method further comprises receiving acoustic signals from one or more sensors remotely located from the cooling system in a temporal domain. The method additionally comprises converting the acoustic signals from the temporal domain to a frequency domain. Furthermore, the method comprises detecting or predicting the occurrence of the critical heat flux in the cooling system using the trained model based on the acoustic signals in the frequency domain.

Other forms of the embodiments of the method described above are in a system and in a computer program product.

In another embodiment of the present disclosure, a computer-implemented method for detecting or predicting critical heat flux in cooling systems comprises extracting a first set of features from image data of a cooling system using a neural network. The method further comprises extracting a second set of features from acoustic data of the cooling system using a fast Fourier transform. The method additionally comprises concatenating the first set of features and the second of features. Furthermore, the method comprises detecting or predicting an occurrence of the critical heat flux in the cooling system by a machine learning regression model using the concatenated features.

Other forms of the embodiments of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present invention can be obtained when the following detailed description is considered in conjunction with the following drawings, in which:

FIG. 1 illustrates a system for practicing the principles of the present disclosure in accordance with an embodiment of the present disclosure;

FIG. 2 is a diagram of the software components used by the heat flux measurement system for detecting or predicting the occurrence of critical heat flux in a cooling system in accordance with an embodiment of the present disclosure;

FIG. 3 illustrates a relationship between heat flux measurements of cooling systems and acoustic signals obtained from the cooling systems in accordance with an embodiment of the present disclosure;

FIG. 4 illustrates extracting features from the acoustic signals, where such extracted features are utilized by a trained machine learning model to detect or predict the occurrence of critical heat flux in accordance with an embodiment of the present disclosure;

FIG. 5 illustrates an embodiment of the present disclosure of the heat flux measurement system which is representative of a hardware environment for practicing the present disclosure;

FIG. 6 is a flowchart of a method for detecting or predicting critical heat flux in cooling systems in accordance with an embodiment of the present disclosure;

FIG. 7 is a flowchart of an alternative method for detecting or predicting critical heat flux in cooling systems in accordance with an embodiment of the present disclosure;

FIGS. 8A-8C illustrate the machine learning model framework for acoustic-based boiling heat flux quantification in accordance with an embodiment of the present disclosure;

FIG. 9 illustrates the rolling sampling process used for segmenting the hydrophone and heat flux data in accordance with an embodiment of the present disclosure;

FIG. 10 illustrates a schematic drawing of the image and acoustic fusion model in accordance with an embodiment of the present disclosure;

FIG. 11 illustrates the R² scores (coefficient of determination scores) for three machine learning models, including the image CNN-MLP, sound FFT-MLP, and image-sound fusion model, in accordance with an embodiment of the present disclosure;

FIG. 12 illustrates the general structure of the three types of fusion models used, namely, early fusion, joint fusion and late fusion, in accordance with an embodiment of the present disclosure;

FIG. 13 shows the coefficient of determination score (R² score) for the models calculated from the test data in accordance with an embodiment of the present disclosure; and

FIG. 14 shows the R² score for three GPR models in accordance with an embodiment of the present disclosure.

### DETAILED DESCRIPTION

As stated above, in two-phase cooling systems, heat may be transferred by the evaporation and condensation of a portion or all of the working fluid. Typically, a liquid near saturation is pumped into the cold plate, where it starts to boil, cooling the electronics and storing the energy in the latent heat of the fluid. The two-phase (liquid and vapor) fluid then flows to the condenser, where the heat is removed, condensing the vapor, so that a single-phase (liquid) exits the condenser, and the cycle repeats.

Such two-phase cooling systems correspond to thermal management systems that provide thermal management of power electronics. The rapid growth of electronic power output necessitates improved thermal management systems. Heat dissipation performance is essential to keep up with high power density applications, such as the subsystems within electric vehicles or data centers. Nucleate boiling (type of boiling that takes place when the surface temperature is hotter than the saturated fluid temperature by a certain amount but where the heat flux is below the critical heat flux) heat transfer accommodates this pursuit while maintaining a relatively low superheat by taking advantage of the high latent heat of the working fluid and efficient vapor removal. Nevertheless, nucleate boiling is bounded by a practical limit known as the critical heat flux, beyond which the heat transfer mode changes to an unstable and far less efficient transition boiling regime. A large fraction of the heater surface will be covered by a vapor film, causing significant heat transfer coefficient deterioration and potential device failures. As a result, heat flux needs to be monitored and regulated in boiling-based thermal management systems.

A variety of heat flux quantification methods have been implemented during pool boiling (vaporization that takes place at a solid surface submerged in a quiescent liquid), including the Joule effect method, the gradient method, and the transverse thermoelectric effect method, among others. The Joule effect method directly calculates the heat flux using the electrical voltage and current applied to the heating element and applies to systems with a large boiling surface area to total surface area ratio, e.g., boiling systems using thin-film heaters (e.g., indium tin oxide (ITO), titanium, and gold). Nevertheless, this method may be subject to large errors for non-uniform heating due to heat loss by spreading in the heater. The electrical power input is more commonly used as a reference to estimate the heat loss rather than directly calculate the boiling heat flux.

The gradient method measures the temperature difference across a layer of material with known thermal conductivity (k) and thickness to determine the temperature gradient at the boiling surface (∇T) and calculates the heat flux using Fourier's law (q=−k∇T). The response time of this approach is limited by thermal diffusion. A linear temperature profile will be obtained under steady-state conditions, which ensures accurate heat flux measurements with high sensitivities. Under transient conditions, inverse modeling of heat conduction with multiple temperature sensors will be required to account for the temporal and spatial nonlinearities.

The transverse thermoelectric effect method leverages materials with anisotropic thermal conductivity, electrical resistance, and thermoelectric coefficient to generate electric fields with a transverse component when heat passes through the principal axes of the materials. This approach allows for ultra-fast response and is thus suitable for transient heat flux measurements. Nevertheless, both the gradient method and the transverse thermoelectric effect method are implemented as contact, surface-mounted sensors, which can be intrusive to boiling and may produce challenges with sensor replacements.

Consequently, there is not currently an effective means for effectively detecting or predicting critical heat flux in cooling systems (thermal management systems) during pool boiling in a non-intrusive manner.

The embodiments of the present disclosure provide a means for effectively detecting or predicting critical heat flux in cooling systems (thermal management systems) during pool boiling in a non-intrusive manner. In particular, embodiments of the present disclosure leverage non-intrusive sensors, including acoustic emission sensors, hydrophones, microphones (e.g., condenser microphones) and/or high-speed cameras, to obtain accurate critical heat flux predictions in the cooling system, such as by coupling frequency domain analysis and nonparametric regression algorithms. Embodiments of the present disclosure will enable accurate and conventional thermal characterization of boiling-based power systems and thermal management systems used to remove and dissipate heat from a device (e.g., nuclear reactors, boilers, high-voltage, high-frequency transformers, high-power density electronics in electric vehicles, data centers, etc.). These and other features will be discussed in greater detail below.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

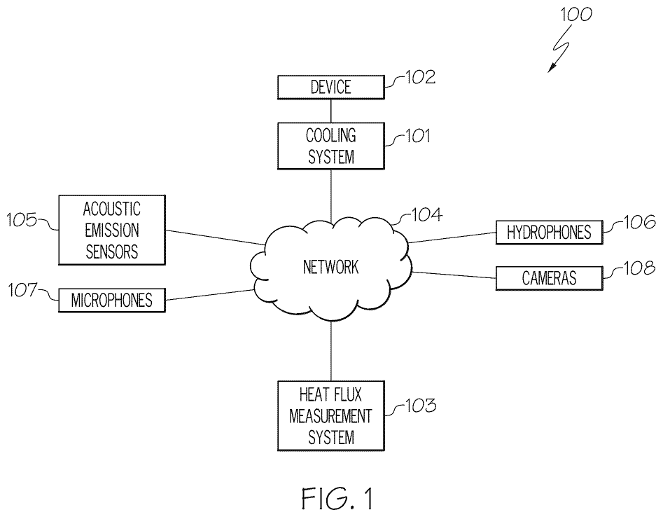

Referring now to the Figures in detail, FIG. 1 illustrates an embodiment of the present disclosure of a system 100 for practicing the principles of the present disclosure. System 100 includes a cooling system 101 configured to remove and dissipate heat from a device 102, such as high power heat sources. Examples of device 102 include, but are not limited to, nuclear reactors, boilers, high-voltage, high-frequency transformers, high-power density electronics in electric vehicles, data centers, etc.

Furthermore, as shown in FIG. 1, system 100 includes a heat flux measurement system 103 connected to cooling system 101 via a network 104. In one embodiment, heat flux measurement system 103 is configured to detect or predict critical heat flux in cooling system 101. “Heat flux” (also referred to as “thermal flux”), as used herein, refers to the flow of energy per unit area per unit time. “Critical heat flux,” as used herein, describes the thermal limit of a phenomenon where a phase change occurs during heating (such as bubbles forming on a metal surface used to heat water), which suddenly decreases the efficiency of heat transfer, thus causing localized overheating of the heating surface.

In one embodiment, heat flux measurement system 103 measures, detects or predicts heat flux, including critical heat flux, in a non-intrusive manner by utilizing sensors that do not interfere with the functioning of cooling system 101. In one embodiment, heat flux measurement system 103 obtains acoustic signals and/or image data from cooling system 101 which are utilized by heat flux measurement system 103 to measure, detect or predict the heat flux, including critical heat flux, in cooling system 101 as discussed further below.

In one embodiment, acoustic signals are obtained from cooling system 101 using one or more acoustic emission sensors 105, one or more hydrophones 106 and/or one or more microphones 107. In one embodiment, such acoustic signals are in the form of sound pressure. An acoustic emission sensor 105, as used herein, refers to a sensor that detects acoustic emission, such as the phenomenon of radiation of acoustic (elastic) waves in solids that occurs when a material undergoes irreversible changes in its internal structure. In one embodiment, such acoustic emission sensors 105 are in contact with cooling system 101. In one embodiment, such acoustic emission sensors 105 are not in contact with cooling system 101. A hydrophone 106 (e.g., High Tech HTI-96-MIN), as used herein, refers to a type of microphone designed to be used underwater (e.g., underwater in a boiling chamber of cooling system 101) for recording or listening to underwater sound. A microphone 107 (e.g., Behringer® ECM8000), as used herein, refers to a transducer that converts sound into an electrical signal. In one embodiment, microphone 107 corresponds to a condenser microphone, which may be placed remotely to cooling system 101. In one embodiment, microphone 107 implements a filter to remove noise from sounds captured by microphone 107. For example, a high-pass or a low-pass filter may be utilized to remove noise from the captured sounds. For example, a high-pass filter (e.g., Butterworth high-pass filter) may pass microphone signals with a frequency higher than a certain cutoff frequency and attenuate microphone signals with frequencies lower than the cutoff frequency. A low-pass filter may pass microphone signals with a frequency lower than a selected cutoff frequency and attenuate microphone signals with frequencies higher than the cutoff frequency.

Furthermore, in one embodiment, image data of cooling system 101 is acquired by heat flux measurement system 103 using one or more camaras 108, such as a high-speed camera (e.g., Phantom® VEO 710 L). For example, such images may correspond to boiling images (e.g., images of pool boiling used by cooling system 101 to cool device 102) involving cooling system 101.

In one embodiment, the sensors discussed herein, such as acoustic emission sensors 105, hydrophones 106, microphones 107 and cameras 108, are located remotely from cooling system 101 and are in communication with heat flux measurement 103 via network 104.

In one embodiment, features from image data, such as images (e.g., pool boiling images) of cooling system 101 captured by cameras 108, as well as features from acoustic data, such as acoustic signals of cooling system 101 acquired by acoustic emission sensors 105, hydrophones 106 and/or microphones 107, are extracted by heat flux measurement system. “Features,” as used herein, refers to characteristics in the data, such as scale, tone, contrast, amplitude, frequency, wavelength, velocity, time period, etc.

In one embodiment, such extracted features are utilized by heat flux measurement system 103 to detect or predict an occurrence of critical heat flux in cooling system 101. In one embodiment, heat flux measurement system 103 builds and trains a model (e.g., regression model) to detect or predict the occurrence of critical heat flux in cooling systems (e.g., cooling system 101) based on the extracted features as discussed further below.

In one embodiment, heat flux measurement system 103 concatenates the features extracted from the image data and the acoustic data, where such concatenated features are used by heat flux measurement system 103 to detect or predict an occurrence of critical heat flux in cooling system 101. In one embodiment, heat flux measurement system 103 builds and trains a model (e.g., regression model) to detect or predict the occurrence of critical heat flux in cooling systems based on the concatenated features as discussed further below.

In one embodiment, upon acquiring acoustic data and/or image data, heat flux measurement system 103 utilizes a model (e.g., regression model) to detect or predict the occurrence of critical heat flux in cooling system 101. In one embodiment, such acoustic data includes acoustic signals that are received in the temporal domain. In one embodiment, heat flux measurement system 103 converts the acoustic signals from the temporal domain to the frequency domain. In one embodiment, heat flux measurement system 103 converts the acoustic signals from the temporal domain to the frequency domain by performing the Fourier transformation on the acoustic signals from the temporal domain. In one embodiment, heat flux measurement system 103 utilizes various software tools for performing the Fourier transformation, including, but are not limited to, Matlab®, FFTPACK, etc.

In one embodiment, heat flux measurement system 103 builds and trains a model (e.g., regression model) to detect or predict the occurrence of critical heat flux in cooling systems (e.g., cooling system 101) based on the acoustic signals as discussed further below.

In one embodiment, heat flux measurement system 103 implements a remedial or a preventive measure based on the detection or prediction of critical heat flux. In one embodiment, heat flux measurement system 103 utilizes a data structure (e.g., table) that includes a listing of remedial/preventive measures based on the detection or prediction of critical heat flux. In one embodiment, heat flux measurement system 103 searches such a data structure for the critical heat flux measurement predicted by the model, such as by using natural language processing. Upon identifying a matching critical heat flux measurement, the associated remedial or preventive measure may be obtained from the data structure and later implemented by heat flux measurement system 103. For example, a predicted critical heat flux measurement of 200 W/cm² may be associated with the remedial action of cooling device 102, such as turning off the heater. In another example, the predicted critical heat flux measurement of 200 W/cm² may be associated with the preventive measure of preventing the overheating or overcooling, respectively, of device 102. In one embodiment, such a data structure is populated by an expert. In one embodiment, the data structure resides in the storage device of heat flux management 103.

A further discussion regarding such features is provided below.

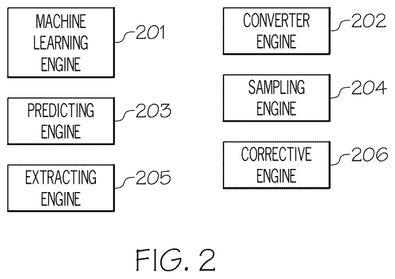

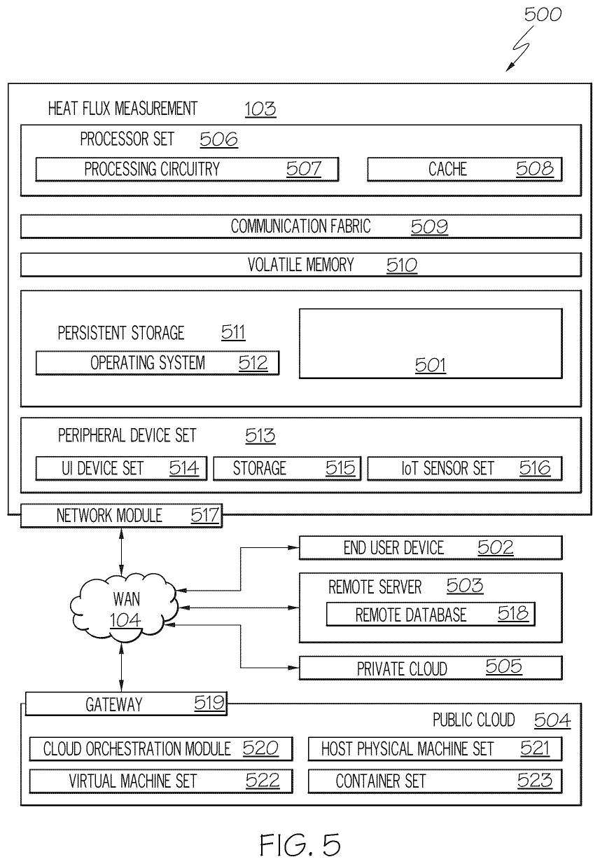

A description of the software components of heat flux measurement system 103 used for measuring, detecting or predicting heat flux measurements, including critical heat flux, in cooling system 101 is provided below in connection with FIG. 2. A description of the hardware configuration of heat flux measurement system 103 is provided further below in connection with FIG. 5.

As previously discussed, in one embodiment, heat flux measurement system 103 is connected to cooling system 101 via network 104. Network 104 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of cooling systems 101, devices 102, heat flux measurement systems 103, networks 104, acoustic emission sensors 105, hydrophones 106, microphones 107, and cameras 108.

A discussion regarding the software components used by heat flux measurement system 103 for detecting or predicting the occurrence of critical heat flux in a cooling system (e.g., cooling system 101) is provided below in connection with FIG. 2

FIG. 2 is a diagram of the software components used by heat flux measurement system 103 for detecting or predicting the occurrence of critical heat flux in a cooling system (e.g., cooling system 101) in accordance with an embodiment of the present disclosure.

Referring to FIG. 2, in conjunction with FIG. 1, heat flux measurement system 103 includes a machine learning engine 201 configured to create or build and train a model (e.g., regression model) to detect or predict the occurrence of critical heat flux in cooling systems, such as cooling system 101.

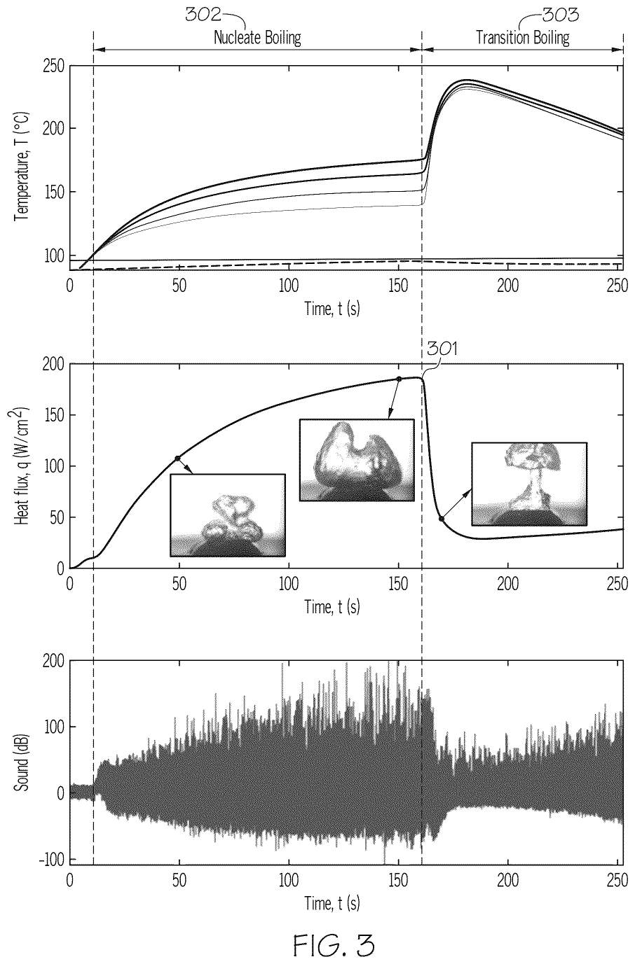

In one embodiment, the model is trained to detect or predict the occurrence of critical heat flux cooling systems, such as cooling system 101, by utilizing features from historical information pertaining to the relationship of heat flux measurements of cooling systems and acoustic signals and/or image data. Such relationships may be established via experimentation by an expert, such as shown in FIG. 3.

Referring to FIG. 3, FIG. 3 illustrates a relationship between heat flux measurements of cooling systems and acoustic signals obtained from the cooling systems in accordance with an embodiment of the present disclosure.

As shown in FIG. 3, when heat flux, q, exceeds a threshold of around 180 W/cm², a critical heat flux 301 may be said to occur. Critical heat flux 301 (CHF) describes the thermal limit of a phenomenon where a phase change occurs during heating (such as bubbles forming on a metal surface used to heat water), which suddenly decreases the efficiency of heat transfer, thus causing localized overheating of the heating surface. In particular, critical heat flux 301 is the peak on the curve between nucleate boiling 302 (type of boiling that takes place when the surface temperature is hotter than the saturated fluid temperature by a certain amount but where the heat flux is below the critical heat flux) and transition boiling 303 (departure from nucleate boiling (DNB)). In response to CHF 301, a preventive or remedial action may be performed.

As further shown in FIG. 3, heat flux, q, is calculated using temperatures (which may be obtained from temperature sensors placed at or near the cooling system, such as cooling system 101) using Fourier's law. As further shown in FIG. 3, acoustic signals obtained from the cooling system, such as cooling system 101, via hydrophones, such as hydrophones 106, may be represented in terms of sound (decibels) versus time (seconds). In one embodiment, such acoustic signals, such as those received from hydrophones (e.g., hydrophones 106), are in the temporal domain. Such signals in the temporal domain may be converted by converter engine 202 to the frequency domain (Hertz, Hz), such as in the form of a spectrogram or power spectrum, by performing the Fourier transformation on the acoustic signals from the temporal domain as discussed above. Such acoustic signals in the frequency domain may be represented in terms of frequency (Hz) and power (dB) versus time (minutes). In one embodiment, converter engine 202 utilizes various software tools for performing the Fourier transformation, including, but are not limited to, Matlab®, FFTPACK, etc.

When critical heat flux occurs, the particular features of the sound, acoustic emission (AE) energy and frequency of the acoustic signals may be identified (features of sound shown in FIG. 3) thereby providing a relationship between the acoustic signals and CHF.

In one embodiment, such information (acoustic signals from the frequency domains when CHF occurs) discussed above may be utilized by machine learning engine 201 to train the model to detect or predict the occurrence of critical heat flux in cooling system 101.

Similarly, in one embodiment, a relationship between critical heat flux 301 (CHF) and the image data (e.g., pool boiling images of cooling systems) acquired by heat flux measurement system 103 may be determined based on historical information pertaining to the relationship of heat flux measurements of cooling systems and image data (e.g., pool boiling images of cooling systems). For example, at heat fluxes slightly below CHF, intense vapor production results in a vapor layer that propagates along the surface which can be seen in pool boiling images. Helmholtz instability produces pronounced waves in this layer, permitting liquid contact with the surface only in ‘wetting fronts’ corresponding to the wave troughs. These wetting fronts sweep along the surface, providing the last source of cooling for the surface. CHF is described to result from the loss of wetting fronts when intense vapor momentum perpendicular to the surface just exceeds the opposing pressure force resulting from interfacial curvature as may be seen in pool boiling images. Hence, such conditions as illustrated in the acquired image data may be utilized to provide a relationship between image data and CHF.

In one embodiment, such information (image data depicting when intense vapor momentum perpendicular to the surface just exceeds the opposing pressure force when CHF occurs) discussed above may be utilized by machine learning engine 201 to train the model to detect or predict the occurrence of critical heat flux in cooling system 101.

In one embodiment, machine learning engine 201 uses a machine learning algorithm (e.g., supervised learning) to build the model to detect or predict the occurrence of critical heat flux in a cooling system, such as cooling system 101, using a sample data set containing historical information (e.g., acoustic signals from the temporal and/or frequency domains when CHF occurs, image data when CHF occurs).

Such a sample data set is referred to herein as the “training data,” which is used by the machine learning algorithm to detect or predict the occurrence of CHF in a cooling system. The algorithm iteratively makes predictions on the training data as to the detection or prediction of the occurrence of CHF in a cooling system until the predictions achieve the desired accuracy as determined by an expert. Examples of such learning algorithms include nearest neighbor, Naïve Bayes, decision trees, linear regression, support vector machines, and neural networks.

After such a model is trained, it may be utilized to detect or predict the occurrence of CHF in cooling system 101 using current image data obtained from cameras 108 and/or acoustic data (e.g., acoustic signals) obtained from acoustic emission sensors 105, hydrophones 106 and/or microphones 107.

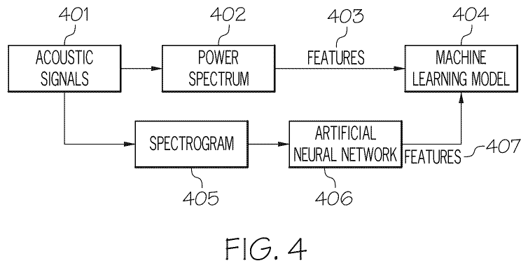

In one embodiment, features are extracted from the acoustic data and/or image data, where such extracted features are utilized by a trained machine learning model (e.g., trained regression model) to detect or predict CHF as discussed below in connection with FIG. 4.

FIG. 4 illustrates extracting features from the acoustic data (e.g., acoustic signals), where such extracted features are utilized by a trained machine learning model (e.g., trained regression model) to detect or predict the occurrence of CHF in accordance with an embodiment of the present disclosure.

Referring to FIG. 4, in one embodiment, acoustic signals 401 may be converted to the frequency domain by converter engine 202, such as in the form of power spectrum data 402, where such features 403 are extracted, such as by extracting engine 205 discussed further below, and utilized by a machine learning model 404 to detect or predict the occurrence of CHF.

In one embodiment, such conversions may be performed by converter engine 202 performing the Fourier transformation on the acoustic signals from the temporal domain. In one embodiment, converter engine 202 utilizes various software tools for performing the Fourier transformation, including, but are not limited to, Matlab®, FFTPACK, etc.

Alternatively, in one embodiment, such acoustic signals 401 may be converted to the frequency domain by converter engine 202, such as in the form of a spectrogram 405, where features 407 of spectrogram 405 are extracted, such as by extracting engine 205 discussed further below, using an artificial neural network 406 (e.g., convolutional neural network) and later inputted to machine learning model 404 to detect or predict the occurrence of CHF.

In one embodiment, the acoustic signals obtained from acoustic emission sensors 105, hydrophones 106 and/or microphones 107 are sampled. In one embodiment, the acoustic signal is segmented into shorter audio clips and matched to a heat flux value. In one embodiment, a rolling sampling method is adopted to generate more data. For example, the entire audio clip is A={s₀, s₁, . . . , sₖ}, where each sᵢ is a reading from hydrophones 106. Furthermore, the matched heat flux values are H={h₀, h₁, . . . , hₖ}, where each hᵢ is a heat flux value found from interpolation (each sᵢ corresponds to hᵢ). As a result, the full-length audio of cooling system 101 (A) is split up into short overlapping audio clips {a₀, a₁, . . . , a_{k-N}_{_{stride}}}, where aᵢ={S_{i*N}_{_{stride}}, . . . , S_{i*N} _{_{Stride}}_{=N}}, where aᵢ={S_{i*N}_{_{stride}}, . . . . , S_{i*N}_{_{stride}}+N}, N is the sequence length, and N_{stride} is the length of the shift made to define each audio clip. Each audio clip (aᵢ) is matched to the approximated heat flux for the last sound value (aᵢ is matched to h_{i*N}_{_{stride}}+N).

In one embodiment, features 403, 407 (e.g., characteristics of the acoustic signals in the frequency domain) are extracted from power spectrum data 402 and/or spectrogram 405 by extracting engine 205 as discussed below.

In one embodiment, converter engine 202 uses FFT (fast Fourier transform) to convert the temporal sequences of acoustic emission signals 401 to power spectra 402 for each audio clip (at), such as by using the function numpy.fft.fft from the NumPy® library. In one embodiment, each audio clip aᵢ is converted to a vector of intensities of frequencies. In one embodiment, these frequency intensity vectors are inputs to model 404 (e.g., regression model) while the corresponding heat fluxes are the outputs.

In one embodiment, for artificial neural network 406 (e.g., convolutional neural network) feature extraction, each audio clip (aᵢ) 401 is first converted to a spectrogram 405 using the signal.spectrogram function from the SciPy® library. In one embodiment, artificial neural network 406 (e.g., convolutional neural network) is utilized by extracting engine 205 to extract features 407 from spectrogram 405. In one embodiment, artificial neural network 406 consists of 3 convolutional layers each followed by a maxpooling layer. The first convolutional layer has 32 filters and a 3 by 3 kernel with a ReLU activation function. The next two convolutional layers have 64 filters and a 3 by 3 kernel with a ReLU activation function. The maxpooling layers have kernels of 2 by 1, 2 by 1, and 2 by 2, respectively. In one embodiment, the output of artificial neural network 406 is flattened and then passed through regressors in order to determine the weights of model 404. After training model 404, the flatted output directly from the layers of artificial neural network 406 is used to train and test model 404 (e.g., regression model). In one embodiment, TensorFlow® is utilized by machine learning engine 201 to perform such an implementation.

In one embodiment, machine learning model 404 corresponds to a multilayer perceptron (MLP) model. MLP is a fully connected class of feedforward artificial neural network. In another embodiment, machine learning model 404 corresponds to a random forest (RFR) model. RFR is an ensemble learning method for classification, regression, and other tasks that operates by constructing a multitude of decision trees at training time. In another embodiment, machine learning model 404 corresponds to a gaussian process regression (GPR) model. GPR is s a nonparametric, Bayesian approach to regression.

In one embodiment, MLP model 404 is composed of layers made of neurons. In each neuron, the inputs (xᵢ) are multiplied by a weight (Wᵢ). Next, these products (xᵢWᵢ) are summed and a bias (b) is added. Then, the output of the neuron is the summation passed through a defined activation function (σ), (out=σ(W₁x₁+W₂x₂+···+Wᵢxᵢ+b)). In one embodiment, the activation function is the Rectified Linear Unit (ReLU) activation function (ReLU=max (0, x)). Initially, the weights and biases of model 404 are randomly assigned, then the data with known labels are passed through the model. The model output and expected output are compared with a loss function and the weights and biases are adjusted to represent the relationship more closely between the inputs and output. In one embodiment, MLP model 404 is constructed with 6 layers. In one embodiment, the layers have 100, 75, 50, 25, 10, and 1 neuron, respectively. The first 5 layers use the Rectified Linear Unit (ReLU) activation function while the last layer does not have an activation function. In one embodiment, MLP model 404 is implemented using TensorFlow®.

In one embodiment, random forest regression model 404 consists of multiple decision trees where each tree's final output is averaged to generate the model's prediction. In one embodiment, RFR model 404 is implemented using the RandomForestRegressor function in Scikit-learn®.

In one embodiment, gaussian process regression model 404 is a probabilistic model that uses a defined kernel for computing covariance among the data. In one embodiment, it uses probability distributions over all possible functions to fit the data. In one embodiment, gaussian process regression model 404 is constructed with a kernel defined as a sum of two kernels; DotProduct and WhiteKernel

$$k ( {x}_{i} , {x}_{j} ) = {σ}_{0}^{2} + {x}_{i} \cdot {x}_{j} + \{ \begin{matrix}1 & i f {x}_{i} == {x}_{j} \\ & 0\end{matrix} .$$

In one embodiment, GPR model 404 is implemented using the GaussianProcessRegressor function with a combination of the WhiteKernel and DotProduct in the Scikit-learn® library.

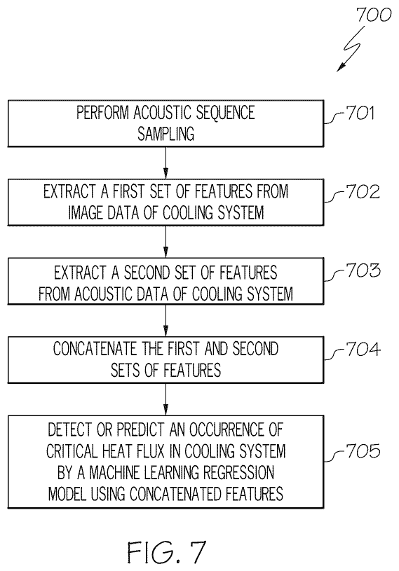

While FIG. 4 is discussed above in connection with a machine learning model (e.g., trained regression model) using extracted features from acoustic signals to detect or predict the occurrence of CHF, the machine learning model of the present disclosure may also utilize extracted features from image data to detect or predict the occurrence of CHF as discussed further below, such as in connection with FIGS. 7-14.

Referring again to FIG. 2, heat flux measurement system 103 further includes a predicting engine 203 configured to detect or predict critical heat flux using the machine learning model (e.g., trained regression model) discussed above.

Furthermore, heat flux measurement system 103 includes a sampling engine 204 configured to performs acoustic sequence sampling as discussed further below in connection with FIGS. 7-13. Sampling engine 204 may utilize various software tools for performing such acoustic sequence sampling, including, but are not limited to, the Audio Toolbox by Matlab®, Ansys, Comsol®, Abaqus®, etc.

Heat flux measurement system 103 additionally includes an extracting engine 205 configured to extracts features from the image data (e.g., pool boiling images acquired from cameras 108) of cooling system 101, such as by using a neural network (e.g., convolutional neural network). Furthermore, extracting engine 204 is configured to extract features from the acquired acoustic data of cooling system 101 (e.g., acoustic signals acquired from acoustic emission sensors 105, hydrophones 106 and/or microphones 107). In one embodiment, such features of the acoustic data are extracted using a neural network, such as a convolutional neural network. A further discussion regarding extracting engine 205 is provided below in connection with FIGS. 7-13.

In one embodiment, predicting engine 203 concatenates the features extracted from the image data and acoustic data, which is utilized to predict critical heat flux using a machine learning model based on the concatenated features. A further discussion regarding predicting engine 203 is provided below in connection with FIGS. 7-13.

Additionally, heat flux measurement system 103 includes a corrective engine 206 configured to implement a remedial or a preventive measure based on the detected or predicted CHF. In one embodiment, corrective engine 203 utilizes a data structure (e.g., table) that includes a listing of remedial/preventive measures based on the detected/predicted CHF. In one embodiment, corrective engine 203 searches such a data structure for the heat flux measurement of a CHF detected or predicted by the model, such as by using natural language processing. Upon identifying a matching critical heat flux measurement, the associated remedial or preventive measure may be obtained from the data structure and later implemented by heat flux measurement system 103. For example, a predicted critical heat flux measurement of 200 W/cm² may be associated with the remedial action of cooling device 102, such as turning off the heater. In another example, the predicted critical heat flux measurement of 200 W/cm² may be associated with the preventive measure of preventing the overheating or overcooling, respectively, of device 102. In one embodiment, such a data structure is populated by an expert. In one embodiment, the data structure resides in the storage device of heat flux management 103.

A further description of these and other features is provided below in connection with the discussion of the method for detecting or predicting the occurrence of CHF in a cooling system.

Prior to the discussion of the method for detecting or predicting the occurrence of CHF in a cooling system, a description of the hardware configuration of heat flux measurement system 103 (FIG. 1) is provided below in connection with FIG. 5.

Referring now to FIG. 5, in conjunction with FIG. 1, FIG. 5 illustrates an embodiment of the present disclosure of heat flux measurement system 103 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods, such as detecting or predicting the occurrence of critical heat flux in cooling systems. In addition to block 501, computing environment 500 includes, for example, heat flux measurement system 103, network 104, such as a wide area network (WAN), end user device (EUD) 502, remote server 503, public cloud 504, and private cloud 505. In this embodiment, heat flux measurement system 103 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Heat flux measurement system 103 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically heat flux measurement system 103, to keep the presentation as simple as possible. Heat flux measurement system 103 may be located in a cloud, even though it is not shown in a cloud in FIG. 5. On the other hand, heat flux measurement system 103 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto heat flux measurement system 103 to cause a series of operational steps to be performed by processor set 506 of heat flux measurement system 103 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of heat flux measurement system 103 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In heat flux measurement system 103, the volatile memory 510 is located in a single package and is internal to heat flux measurement system 103, but, alternatively or additionally, the volatile memory may be distributed over multiple packages and/or located externally with respect to heat flux measurement system 103.

Persistent Storage 511 is any form of non-volatile storage for computers that is now known or to be developed in the future. The non-volatility of this storage means that the stored data is maintained regardless of whether power is being supplied to heat flux measurement system 103 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of heat flux measurement system 103. Data communication connections between the peripheral devices and the other components of heat flux measurement system 103 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where heat flux measurement system 103 is required to have a large amount of storage (for example, where heat flux measurement system 103 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows heat flux measurement system 103 to communicate with other computers through WAN 104. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to heat flux measurement system 103 from an external computer or external storage device through a network adapter card or network interface included in network module 517.

WAN 104 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates heat flux measurement system 103), and may take any of the forms discussed above in connection with heat flux measurement system 103. EUD 502 typically receives helpful and useful data from the operations of heat flux measurement system 103. For example, in a hypothetical case where heat flux measurement system 103 is designed to provide a recommendation to an end user, this recommendation would typically be communicated from network module 517 of heat flux measurement system 103 through WAN 104 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to heat flux measurement system 103. Remote server 503 may be controlled and used by the same entity that operates heat flux measurement system 103. Remote server 503 represents the machine(s) that collect and store helpful and useful data for use by other computers, such as heat flux measurement system 103. For example, in a hypothetical case where heat flux measurement system 103 is designed and programmed to provide a recommendation based on historical data, then this historical data may be provided to heat flux measurement system 103 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 104 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to detect or predict the occurrence of critical heat flux in a cooling system, such as cooling system 101. In one embodiment, such components may be implemented in hardware. The functions discussed above performed by such components are not generic computer functions. As a result, heat flux measurement system 103 is a particular machine that is the result of implementing specific, non-generic computer functions.

In one embodiment, the functionality of such software components of heat flux measurement system 103, including the functionality for detecting or predicting the occurrence of critical heat flux may be embodied in an application specific integrated circuit.

As stated above, in two-phase cooling systems, heat may be transferred by the evaporation and condensation of a portion or all of the working fluid. Typically, a liquid near saturation is pumped into the cold plate, where it starts to boil, cooling the electronics and storing the energy in the latent heat of the fluid. The two-phase (liquid and vapor) fluid then flows to the condenser, where the heat is removed, condensing the vapor, so that a single-phase (liquid) exits the condenser, and the cycle repeats. Such two-phase cooling systems correspond to thermal management systems that provide thermal management of power electronics. The rapid growth of electronic power output necessitates improved thermal management systems. Heat dissipation performance is essential to keep up with high power density applications, such as the subsystems within electric vehicles or data centers. Nucleate boiling (type of boiling that takes place when the surface temperature is hotter than the saturated fluid temperature by a certain amount but where the heat flux is below the critical heat flux) heat transfer accommodates this pursuit while maintaining a relatively low superheat by taking advantage of the high latent heat of the working fluid and efficient vapor removal. Nevertheless, nucleate boiling is bounded by a practical limit known as the critical heat flux, beyond which the heat transfer mode changes to an unstable and far less efficient transition boiling regime. A large fraction of the heater surface will be covered by a vapor film, causing significant heat transfer coefficient deterioration and potential device failures. As a result, heat flux needs to be monitored and regulated in boiling-based thermal management systems. A variety of heat flux quantification methods have been implemented during pool boiling (vaporization that takes place at a solid surface submerged in a quiescent liquid), including the Joule effect method, the gradient method, and the transverse thermoelectric effect method, among others. The Joule effect method directly calculates the heat flux using the electrical voltage and current applied to the heating element and applies to systems with a large boiling surface area to total surface area ratio, e.g., boiling systems using thin-film heaters (e.g., indium tin oxide (ITO), titanium, and gold). Nevertheless, this method may be subject to large errors for non-uniform heating due to heat loss by spreading in the heater. The electrical power input is more commonly used as a reference to estimate the heat loss rather than directly calculate the boiling heat flux. The gradient method measures the temperature difference across a layer of material with known thermal conductivity (k) and thickness to determine the temperature gradient at the boiling surface (ΔT) and calculates the heat flux using Fourier's law (q=−kΔT). The response time of this approach is limited by thermal diffusion. A linear temperature profile will be obtained under steady-state conditions, which ensures accurate heat flux measurements with high sensitivities. Under transient conditions, inverse modeling of heat conduction with multiple temperature sensors will be required to account for the temporal and spatial nonlinearities. The transverse thermoelectric effect method leverages materials with anisotropic thermal conductivity, electrical resistance, and thermoelectric coefficient to generate electric fields with a transverse component when heat passes through the principal axes of the materials. This approach allows for ultra-fast response and is thus suitable for transient heat flux measurements. Nevertheless, both the gradient method and the transverse thermoelectric effect method are implemented as contact, surface-mounted sensors, which can be intrusive to boiling and may produce challenges with sensor replacements. Consequently, there is not currently an effective means for effectively detecting or predicting critical heat flux in cooling systems (thermal management systems) during pool boiling in a non-intrusive manner.

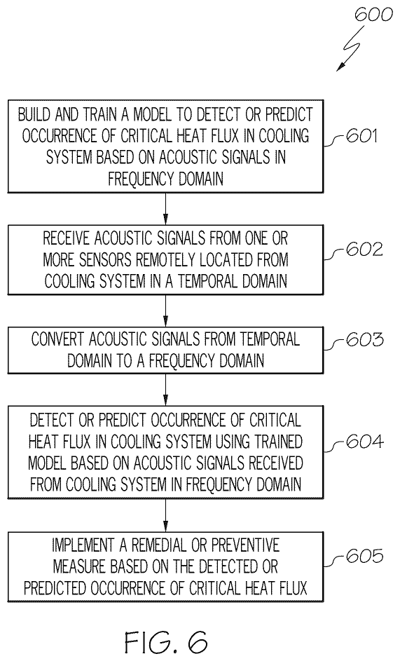

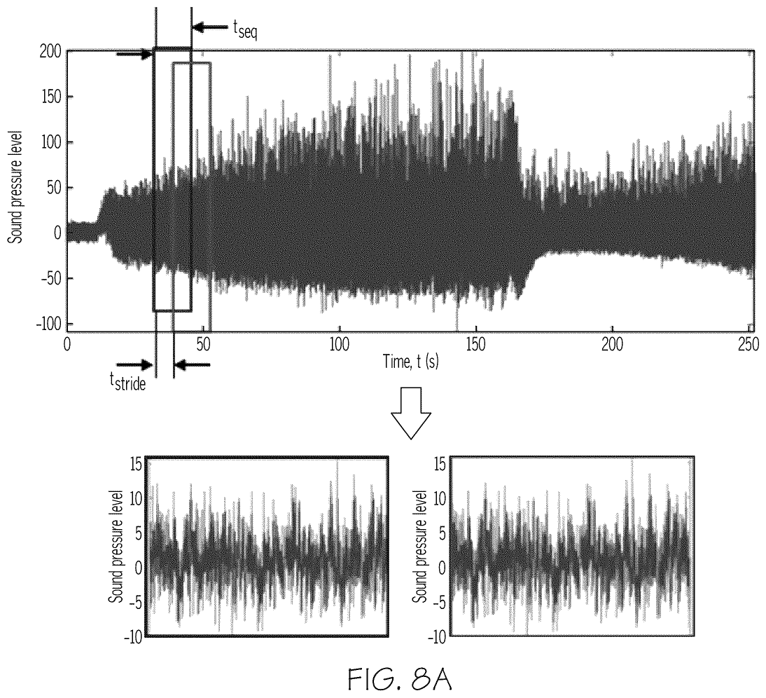

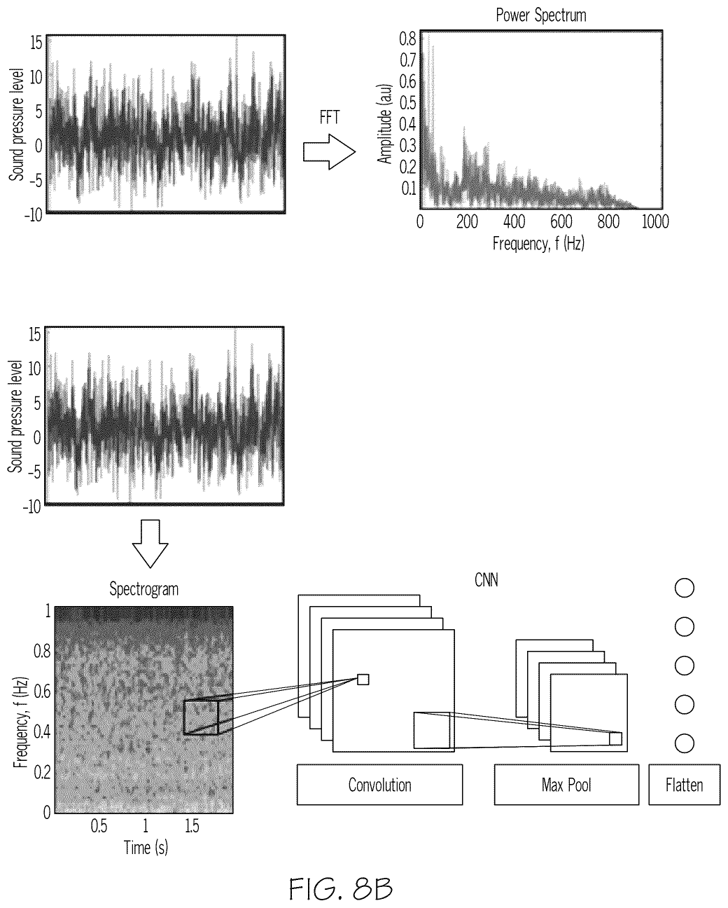

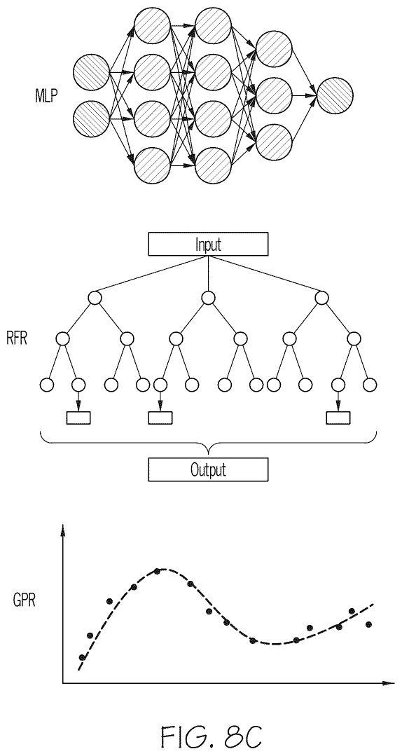

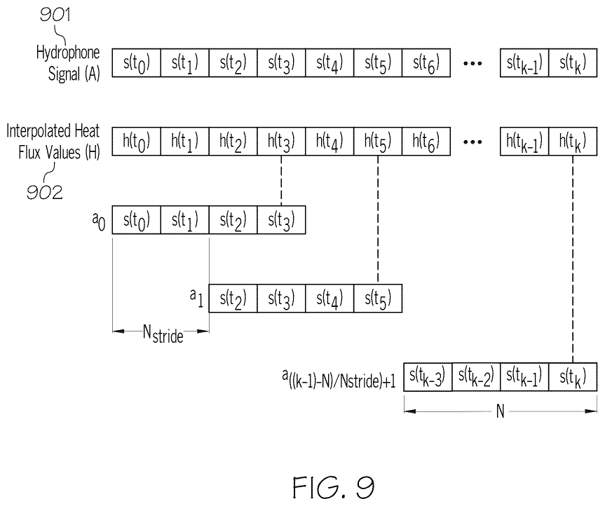

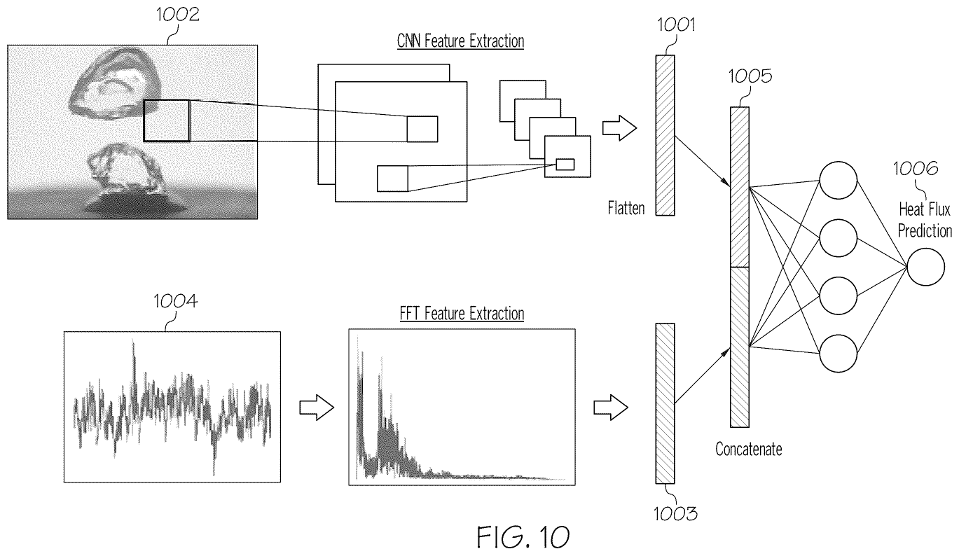

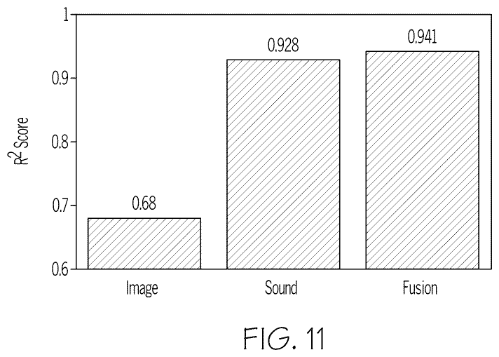

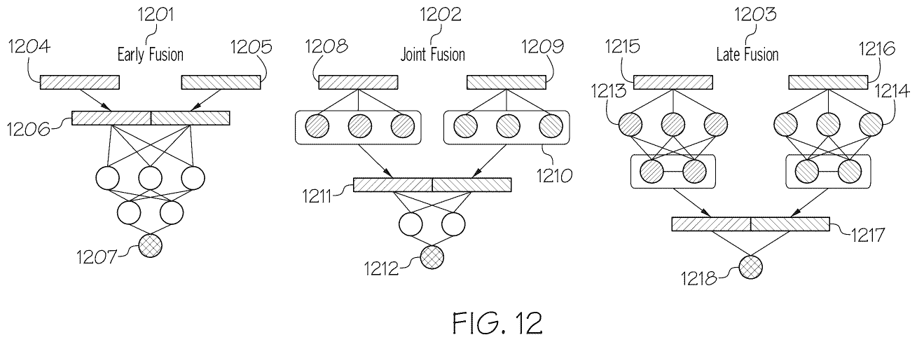

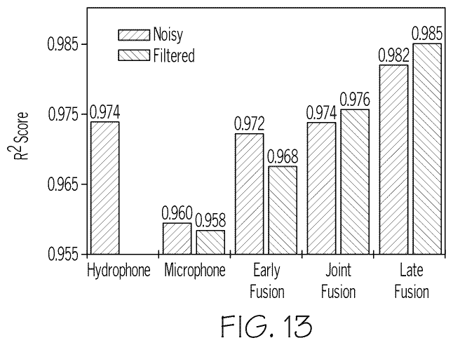

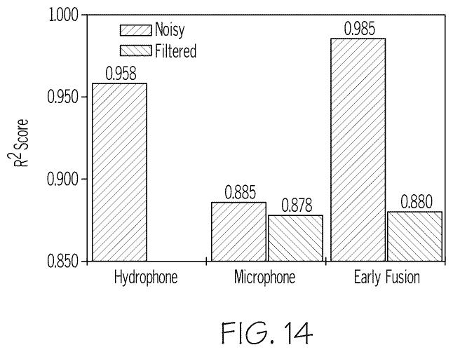

The embodiments of the present disclosure provide a means for effectively detecting or predicting the occurrence of CHF in cooling systems in a non-intrusive manner as discussed below in connection with FIGS. 6-13. FIG. 6 is a flowchart of a method for detecting or predicting the occurrence of critical heat flux in cooling systems. FIG. 7 is a flowchart of an alternative method for detecting or predicting the occurrence of critical heat flux in cooling systems. FIGS. 8A-8C illustrate the machine learning model framework for acoustic-based boiling heat flux quantification. FIG. 9 illustrates the rolling sampling process used for segmenting the hydrophone and heat flux data. FIG. 10 illustrates a schematic drawing of the image and acoustic fusion model. FIG. 11 illustrates the R² scores (coefficient of determination scores) for three machine learning models, including the image CNN-MLP, sound FFT-MLP, and image-sound fusion model. FIG. 12 illustrates the general structure of the three types of fusion models used, namely, early fusion, joint fusion and late fusion. FIG. 13 shows the coefficient of determination score (R² score) for the models calculated from the test data. FIG. 14 shows the R² score for three GPR models.

As stated above, FIG. 6 is a flowchart of a method 600 for detecting or predicting the occurrence of critical heat flux in cooling systems, such as cooling system 101, in accordance with an embodiment of the present disclosure.

Referring to FIG. 6, in conjunction with FIG. 1-5, in step 601, machine learning engine 201 of heat flux measurement system 103 builds and trains a model to detect or predict the occurrence of critical heat flux in cooling system 101 based on acoustic signals in a frequency domain.

As discussed above, in one embodiment, the model is trained to detect or predict the occurrence of critical heat flux cooling systems, such as cooling system 101, by utilizing features from historical information pertaining to the relationship of heat flux measurements of cooling systems and acoustic signals and/or image data. Such relationships may be established via experimentation by an expert, such as shown in FIG. 3.

As shown in FIG. 3, when heat flux, q, exceeds a threshold of around 180 W/cm², a critical heat flux 301 may be said to occur. Critical heat flux 301 (CHF) describes the thermal limit of a phenomenon where a phase change occurs during heating (such as bubbles forming on a metal surface used to heat water), which suddenly decreases the efficiency of heat transfer, thus causing localized overheating of the heating surface. In particular, critical heat flux 301 is the peak on the curve between nucleate boiling 302 (type of boiling that takes place when the surface temperature is hotter than the saturated fluid temperature by a certain amount but where the heat flux is below the critical heat flux) and transition boiling 303 (departure from nucleate boiling (DNB)). In response to CHF 301, a preventive or remedial action may be performed.

As further shown in FIG. 3, heat flux, q, is calculated using temperatures (which may be obtained from temperature sensors placed at or near the cooling system, such as cooling system 101) using Fourier's law. As further shown in FIG. 3, acoustic signals obtained from the cooling system, such as cooling system 101, via hydrophones, such as hydrophones 106, may be represented in terms of sound (decibels) versus time (seconds). In one embodiment, such acoustic signals, such as those received from hydrophones (e.g., hydrophones 106), are in the temporal domain. Such signals in the temporal domain may be converted by converter engine 202 to the frequency domain (Hertz, Hz), such as in the form of a spectrogram or power spectrum, by performing the Fourier transformation on the acoustic signals from the temporal domain as discussed above. Such acoustic signals in the frequency domain may be represented in terms of frequency (Hz) and power (dB) versus time (minutes). In one embodiment, converter engine 202 utilizes various software tools for performing the Fourier transformation, including, but are not limited to, Matlab®, FFTPACK, etc.

When critical heat flux occurs, the particular features of the sound, acoustic emission (AE) energy and frequency of the acoustic signals may be identified (features of sound shown in FIG. 3) thereby providing a relationship between the acoustic signals and CHF.

In one embodiment, such information (acoustic signals from the frequency domains when CHF occurs) discussed above may be utilized by machine learning engine 201 to train the model to detect or predict the occurrence of critical heat flux in cooling system 101.

Similarly, in one embodiment, a relationship between critical heat flux 301 (CHF) and the image data (e.g., pool boiling images of cooling systems) acquired by heat flux measurement system 103 may be determined based on historical information pertaining to the relationship of heat flux measurements of cooling systems and image data (e.g., pool boiling images of cooling systems). For example, at heat fluxes slightly below CHF, intense vapor production results in a vapor layer that propagates along the surface which can be seen in pool boiling images. Helmholtz instability produces pronounced waves in this layer, permitting liquid contact with the surface only in ‘wetting fronts’ corresponding to the wave troughs. These wetting fronts sweep along the surface, providing the last source of cooling for the surface. CHF is described to result from the loss of wetting fronts when intense vapor momentum perpendicular to the surface just exceeds the opposing pressure force resulting from interfacial curvature as may be seen in pool boiling images. Hence, such conditions as illustrated in the acquired image data may be utilized to provide a relationship between image data and CHF.

In one embodiment, such information (image data depicting when intense vapor momentum perpendicular to the surface just exceeds the opposing pressure force when CHF occurs) discussed above may be utilized by machine learning engine 201 to train the model to detect or predict the occurrence of critical heat flux in cooling system 101.

In one embodiment, machine learning engine 201 uses a machine learning algorithm (e.g., supervised learning) to build the model to detect or predict the occurrence of critical heat flux in a cooling system, such as cooling system 101, using a sample data set containing historical information (e.g., acoustic signals from the temporal and/or frequency domains when CHF occurs, image data when CHF occurs).

Such a sample data set is referred to herein as the “training data,” which is used by the machine learning algorithm to detect or predict the occurrence of CHF in a cooling system. The algorithm iteratively makes predictions on the training data as to the detection or prediction of the occurrence of CHF in a cooling system until the predictions achieve the desired accuracy as determined by an expert. Examples of such learning algorithms include nearest neighbor, Naïve Bayes, decision trees, linear regression, support vector machines, and neural networks.

In step 602, heat flux measurement system 103 receives acoustic signals from one or more sensors (e.g., acoustic emission sensors 105, hydrophones 106 and/or microphones 107) remotely located from cooling system 101 in a temporal domain as discussed above.

In step 603, converter engine 202 of heat flux measurement system 103 converts the acoustic signals from the temporal domain to a frequency domain.

As discussed above, in one embodiment, converter engine 202 converts acoustic signals 401 to the frequency domain, such as in the form of power spectrum data 402, where features 403 are extracted and utilized by a machine learning model 404 to detect or predict the occurrence of CHF.

In one embodiment, such conversions may be performed by converter engine 202 performing the Fourier transformation on the acoustic signals from the temporal domain. In one embodiment, converter engine 202 utilizes various software tools for performing the Fourier transformation, including, but are not limited to, Matlab®, FFTPACK, etc.

Alternatively, in one embodiment, such acoustic signals 401 may be converted to the frequency domain by converter engine 202, such as in the form of a spectrogram 405, where features 407 of spectrogram 405 are extracted using an artificial neural network 406 (e.g., convolutional neural network) and later inputted to machine learning model 404 to detect or predict the occurrence of CHF.

In step 604, predicting engine 203 of heat flux measurement system 103 utilizes the trained model to detect or predict the occurrence of critical heat flux in cooling system 101 based on the acoustic signals received from cooling system 101 in the frequency domain.

As stated above, in one embodiment, the acoustic signals obtained from acoustic emission sensors 105, hydrophones 106 and/or microphones 107 are sampled. In one embodiment, the acoustic signal is segmented into shorter audio clips and matched to a heat flux value. In one embodiment, a rolling sampling method is adopted to generate more data. For example, the entire audio clip is A={s₀, s₁, . . . , sₖ}, where each sᵢ is a reading from hydrophones 106. Furthermore, the matched heat flux values are H={h₀, h₁, . . . , hₖ}, where each hᵢ is a heat flux value found from interpolation (each sᵢ corresponds to hᵢ). As a result, the full-length audio of cooling system 101 (A) is split up into short overlapping audio clips {a₀, a₁, . . . , a_{k-N}_{_{stride}}}, where aᵢ={S_{i*N}_{_{stride}}, . . . , S_{i*N}_{_{stride}}+N}, N is the sequence length, and N_{stride} is the length of the shift made to define each audio clip. Each audio clip (aᵢ) is matched to the approximated heat flux for the last sound value (aᵢ is matched to h_{i*N}_{_{stride}}+N).

In one embodiment, features 403, 407 (e.g., characteristics of the acoustic signals in the frequency domain) are extracted from power spectrum data 402 and/or spectrogram 405 by extracting engine 205.

In one embodiment, converter engine 202 uses FFT to convert the temporal sequences of acoustic emission signals 401 to power spectra 402 for each audio clip (at), such as by using the function numpy.fft.fft from the NumPy® library. In one embodiment, each audio clip aᵢ is converted to a vector of intensities of frequencies. In one embodiment, these frequency intensity vectors are inputs to model 404 (e.g., regression model) while the corresponding heat fluxes are the outputs.

In one embodiment, for artificial neural network 406 (e.g., convolutional neural network) feature extraction, each audio clip (aᵢ) 401 is first converted to a spectrogram 405 using the signal.spectrogram function from the SciPy® library. In one embodiment, artificial neural network 406 (e.g., convolutional neural network) is utilized by extracting engine 205 to extract features 407 from spectrogram 405. In one embodiment, artificial neural network 406 consists of 3 convolutional layers each followed by a maxpooling layer. The first convolutional layer has 32 filters and a 3 by 3 kernel with a ReLU activation function. The next two convolutional layers have 64 filters and a 3 by 3 kernel with a ReLU activation function. The maxpooling layers have kernels of 2 by 1, 2 by 1, and 2 by 2, respectively. In one embodiment, the output of artificial neural network 406 is flattened and then passed through regressors in order to determine the weights of model 404. After training model 404, the flatted output directly from the layers of artificial neural network 406 is used to train and test model 404 (e.g., regression model). In one embodiment, TensorFlow® is utilized by machine learning engine 201 to perform such an implementation.

In one embodiment, machine learning model 404 corresponds to a multilayer perceptron (MLP) model. MLP is a fully connected class of feedforward artificial neural network. In another embodiment, machine learning model 404 corresponds to a random forest (RFR) model. RFR is an ensemble learning method for classification, regression, and other tasks that operates by constructing a multitude of decision trees at training time. In another embodiment, machine learning model 404 corresponds to a gaussian process regression (GPR) model. GPR is s a nonparametric, Bayesian approach to regression.

In one embodiment, MLP model 404 is composed of layers made of neurons. In each neuron, the inputs (xᵢ) are multiplied by a weight (Wᵢ). Next, these products (xᵢWᵢ) are summed and a bias (b) is added. Then, the output of the neuron is the summation passed through a defined activation function (σ), (out=σ(W₁x₁+W₂x₂+···+Wᵢxᵢ+b)). In one embodiment, the activation function is the Rectified Linear Unit (ReLU) activation function (ReLU=max (0, x)). Initially, the weights and biases of model 404 are randomly assigned, then the data with known labels are passed through the model. The model output and expected output are compared with a loss function and the weights and biases are adjusted to represent the relationship more closely between the inputs and output. In one embodiment, MLP model 404 is constructed with 6 layers. In one embodiment, the layers have 100, 75, 50, 25, 10, and 1 neuron, respectively. The first 5 layers use the Rectified Linear Unit (ReLU) activation function while the last layer does not have an activation function. In one embodiment, MLP model 404 is implemented using TensorFlow®.

In one embodiment, random forest regression model 404 consists of multiple decision trees where each tree's final output is averaged to generate the model's prediction. In one embodiment, RFR model 404 is implemented using the RandomForestRegressor function in Scikit-learn®.

In one embodiment, gaussian process regression model 404 is a probabilistic model that uses a defined kernel for computing covariance among the data. In one embodiment, it uses probability distributions over all possible functions to fit the data. In one embodiment, gaussian process regression model 404 is constructed with a kernel defined as a sum of two kernels; DotProduct and WhiteKernel

$$k ( {x}_{i} , {x}_{j} ) = {σ}_{0}^{2} + {x}_{i} \cdot {x}_{j} + \{ \begin{matrix}1 & i f {x}_{i} == {x}_{j} \\ & 0\end{matrix} .$$

In one embodiment, GPR model 404 is implemented using the GaussianProcessRegressor function with a combination of the WhiteKernel and DotProduct in the Scikit-learn® library.

In step 605, corrective engine 203 of heat flux measurement system 103 implements remedial or preventive measures based on the detected or predicted occurrence of critical heat flux.

As discussed above, corrective engine 203 implements a remedial or a preventive measure based on the detected or predicted CHF. In one embodiment, corrective engine 203 utilizes a data structure (e.g., table) that includes a listing of remedial/preventive measures based on the detected/predicted CHF. In one embodiment, corrective engine 203 searches such a data structure for the heat flux measurement of a CHF detected or predicted by the model, such as by using natural language processing. Upon identifying a matching critical heat flux measurement, the associated remedial or preventive measure may be obtained from the data structure and later implemented by heat flux measurement system 103. For example, a predicted critical heat flux measurement of 200 W/cm² may be associated with the remedial action of cooling device 102, such as turning off the heater. In another example, the predicted critical heat flux measurement of 200 W/cm² may be associated with the preventive measure of preventing the overheating or overcooling, respectively, of device 102. In one embodiment, such a data structure is populated by an expert. In one embodiment, the data structure resides in the storage device (e.g., storage device 511, 515) of heat flux management 103.

An alternative embodiment of predicting heat flux is discussed below in connection with FIGS. 7 and 8A-8C. FIG. 7 is a flowchart of an alternative method 700 for detecting or predicting the occurrence of critical heat flux in cooling systems in accordance with an embodiment of the present disclosure. FIGS. 8A-8C illustrate the machine learning model framework for acoustic-based boiling heat flux quantification in accordance with an embodiment of the present disclosure.

Referring to FIG. 7, in conjunction with FIGS. 1-5 and 8A-8C, in step 701, sampling engine 204 of heat flux measurement system 103 performs acoustic sequence sampling as illustrated in FIG. 8A. Sampling engine 204 may utilize various software tools for performing such acoustic sequence sampling, including, but are not limited to, the Audio Toolbox by Matlab®, Ansys, Comsol®, Abaqus®, etc.

In step 702, extracting engine 205 of heat flux measurement system 103 extracts features from the image data (e.g., pool boiling images acquired from cameras 108) of cooling system 101, such as by using a neural network (e.g., convolutional neural network).

In step 703, extracting engine 205 of heat flux measurement system 103 extracts features from the acoustic data of cooling system 101 (e.g., acoustic signals acquired from acoustic emission sensors 105, hydrophones 106 and/or microphones 107) as illustrated in FIG. 8B. In one embodiment, the acquired acoustic signals in the temporal domain are converted into the frequency domain by converter engine 202, such as in the form of a spectrogram or power spectrum, by performing the Fourier transformation on the acoustic signals from the temporal domain as discussed above. Such acoustic signals in the frequency domain may be represented in terms of frequency (Hz) and power (dB) versus time (minutes). In one embodiment, converter engine 202 utilizes various software tools for performing the Fourier transformation, including, but are not limited to, Matlab®, FFTPACK, etc.

In one embodiment, such features of the transformed acoustic signals are extracted using a neural network, such as a convolutional neural network, as shown in FIG. 8B.

In step 704, predicting engine 203 of heat flux measurement system 103 concatenates the features extracted in steps 702, 703.

In step 705, predicting engine 203 of heat flux measurement system 103 detects or predicts an occurrence of critical heat flux in cooling system 101 using a machine learning model (e.g., MLP (multilayer perceptron), RFR (random forest), GPR (Gaussian process regression), etc.) based on the concatenated features as illustrated in FIG. 8C.

A further discussion regarding method 700 is provided below.

In one embodiment, in connection with performing sequence sampling in step 701, the acoustic signal is segmented into shorter audio clips and matched to a heat flux value. In one embodiment, sampling engine 204 performs a rolling sampling method to generate more data as shown in FIG. 9. FIG. 9 illustrates the rolling sampling process used for segmenting the hydrophone data 901 and heat flux data 902 in accordance with an embodiment of the present disclosure.

Referring to FIG. 9, such a process is explained by letting the entire audio clip be A={s(t₀), s(t₁), . . . , s(tₖ)}, where each s(tᵢ) is a reading from the hydrophone (e.g., hydrophone 106) at the time tᵢ and k+1 is the number of samples in the audio clip. In one embodiment, due to the differing sampling rates, linear interpolation is used to find the heat flux value corresponding to each acoustic recording. The matched heat flux values are H={h(t₀), h(t₁), . . . h(tₖ)}, where each h(tᵢ) is an approximated heat flux value at the time tᵢ. Then, the full-length audio of the boiling experiment (A) is split up into short overlapping audio clips {a₀, a₁, . . . , a_{((k-1)-N)/N}_{_{stride)}}₊₁}, where aᵢ={S(t_{i*N}_{_{stride}}), S(t_{i*N}_{_{stride}}₊₁, . . . , s(t_{i*N}_{_{stride}}_{+N-1})}, N is the sequence length, and N_{stride} is the stride (length of the shift made to define each audio clip). In one embodiment, each audio clip (aᵢ) is matched to the approximated heat flux for the last sound value (aᵢ is matched to h(t_{i*N}_{_{stride}}_{+N-1})).

In one embodiment, the initial dataset (DS1) consisted of overlapping audio clips corresponding to heat flux values with the original sampling rate (SR) of 2,048 Hz, a sequence length of 4,000 samples, and a stride of 100 samples. In one embodiment, the dataset is used for comparing the performance of different regression models. To determine the effect of the modifications on the data, multiple datasets are created by changing the sequence lengths, strides, and sampling rate as shown below in Table 1. In one embodiment, to adjust the sampling rate, the original sound is downsampled by removing some values to replicate different sampling rates. For example, a sampling rate of 1,024 Hz is defined as A={s(t₀),s(t₂),s(t₄), . . . }. After downsampling the sound, the rolling sampling process is used to generate datasets with different sequence lengths and strides (DS2-DS20).

In order to compare the acoustic and thermal properties of different boiling regimes, in one embodiment, the original data is separated into two sections, e.g., nucleate boiling and transition boiling. In one embodiment, two sub-datasets, i.e., DSN and DST, are generated using the rolling sampling technique with a sequence length of 4,000 samples and a stride of 100 samples for the nucleate boiling regime and a stride of 58 samples for the transition boiling regime, as shown below in Table 2. Different strides may be used to generate the same amount of data for each regime for training. In one embodiment, for each boiling regime dataset, the data is shuffled and split into 90% training and 10% testing sets. Another training set (DSF) is created by combining and shuffling the training datasets for both regimes.

TABLE 1
List of datasets generated by varying sequence
length, stride, and sampling rate.

| | Sampling | | |
|---|---|---|---|
| | Rate, SR | Sequence | Stride, |
| Dataset | (Hz) | Length, N | N_{stride} |
| DS1 | 2,048 | 4000 | 100 |
| DS2, DS3, DS4, DS5 | 2,048 | 1000, 2000, 3000, | 100 |
| | | 8000 | |
| DS6, DS7, DS8, DS9, | 1,024 | 1000, 2000, 3000, | 50 |
| DS10 | | 4000, 8000 | |
| DS11, DS12, DS13, | 512 | 1000, 2000, 3000, | 25 |
| DS14, DS15 | | 4000, 8000 | |
| DS16, DS17, DS18, | 256 | 1000, 2000, 3000, | 12 |
| DS19, DS20 | | 4000, 8000 | |

TABLE 2
Two separate datasets generated for different boiling regimes.

| | Sampling | | | |
|---|---|---|---|---|
| | Rate, SR | Sequence | Stride, | |
| Dataset | (Hz) | Length, N | N_{stride} | Boiling Regime |
| DSN | 2,048 | 4,000 | 100 | Nucleate boiling |
| DST | 2,048 | 4,000 | 58 | Transition boiling |
| DSF | 2,048 | 4,000 | 100, 58 | Nucleate & Transition |

With respect to step 703 involving the extraction of features from the sampled acoustic sequences, different methods may be used for feature extraction, such as the FFT method and the CNN model.

With respect to the FFT method, in one embodiment, FFT is used to convert the temporal sequences to power spectra for each audio clip (aⱼ) using the function numpy.fft.fft from the NumPy® library. In one embodiment, each audio clip aⱼ is converted to a vector of intensities of frequencies. These frequency intensity vectors act as inputs to the regression models while the corresponding heat fluxes are the outputs.

In one embodiment, for the CNN feature extraction, each audio clip (aⱼ) is first converted to a spectrogram using the signal.spectrogram function from the SciPy® library. The CNN portion consists of 3 convolutional layers each followed by a maxpooling layer. In one embodiment, the first convolutional layer has 32 filters and a 3 by 3 kernel with a Rectified Linear Unit (ReLU) activation function. In one embodiment, the next two convolutional layers have 64 filters and a 3 by 3 kernel with a ReLU activation function. In one embodiment, the maxpooling layers have kernels of 2 by 1, 2 by 1, and 2 by 2, respectively. The output may then be flattened and passed through the regressors to determine the weights of the model. After training the model, the flatted output directly from the CNN layers may be used to train and test the regression models. In one embodiment, the CNN feature extraction is implemented using TensorFlow®.

In one embodiment, both feature extracting methods are applied to DS1 and three different regression algorithms are trained with each type of feature. The power spectrum-GPR method was found to perform best in terms of speed and accuracy and was implemented on the remaining datasets.

In one embodiment, three supervised regression algorithms are trained and tested: MLP (multilayer perceptron), RFR (random forest), and GPR (Gaussian process regression). An MLP is composed of layers made of neurons. In each neuron, the inputs (xᵢ) are multiplied by a weight (Wᵢ). Next, these products (xᵢWᵢ) are summed and a bias (b) is added. Then, the output of the neuron is the summation passed through a defined activation function (σ), (out=σ(W₁x₁+W₂x₂+ . . . +Wᵢxᵢ+b)). A common activation function is the ReLU activation function (ReLU=max (0,x)). In one embodiment, initially, the weights and biases of the model are randomly assigned, then the data with known labels are passed through the model. The model output and expected output are compared with a loss function, and the weights and biases are adjusted to represent the relationship more closely between the inputs and output. In one embodiment, the MLP model is constructed with 6 layers. The layers had 100, 75, 50, 25, 10, and 1 neuron, respectively. The first 5 layers used the ReLU activation function while the last layer did not have an activation function. In one embodiment, DS1 is used for training with an 80%-20%, train-test split. In one embodiment, the model is trained using stochastic gradient descent and a mean average error loss function with 10% of the training data being used for validation. In one embodiment, early stopping is implemented, such that the model stops training after the validation loss increased for three consecutive epochs.

A random forest regression model consists of multiple decision trees where each tree's final output is averaged to generate the model's prediction. In one embodiment, an RFR model with a max depth of 100 is trained and tested with DS1. In one embodiment, DS1 is shuffled and separated into 80% training and 20% testing.

Gaussian process regression is another type of supervised regression algorithm. Gaussian process regression is a probabilistic model that uses a defined kernel for computing covariance among the data. It uses probability distributions over all possible functions to fit the data. In one embodiment, the Gaussian process regression models are constructed with a kernel defined as a sum of two kernels; DotProduct and WhiteKernel

$$k ( {x}_{i} , {x}_{j} ) = {σ}_{0}^{2} + {x}_{i} \cdot {x}_{j} + \{ \begin{matrix}1 & i f {x}_{i} == {x}_{j} \\ & 0\end{matrix} .$$

In one embodiment, twenty models are trained and tested using datasets DS1-DS20 with an 80%-20% train-test split. Three other GPR models are trained and tested with DSN, DST, and DSF, all with a 90%-10% train-test split. In one embodiment, all the models are implemented in Python® using libraries, such as Scikit-learn® or TensorFlow®. In one embodiment, the data is shuffled and split into testing and training sets using the Train_Test_Split function from Scikit-learn®. In one embodiment, the Random Forest regression model is implemented using the RandomForestRegressor function in Scikit-learn®. In one embodiment, the MLP model is implemented using TensorFlow®. In one embodiment, the GPR model is implemented using the GaussianProcessRegressor function with a combination of the WhiteKernel and DotProduct, all of which are available in the Scikit-learn® library.

As previously discussed, corrective engine 206 of heat flux measurement system 103 predicts heat flux by performing regression on the extracted features. A further discussion regarding predicting heat flux is provided below in connection with optical-acoustic fusion.

In one embodiment, in order to show the potential of utilizing both high-speed image data and acoustic signals together, three different machine-learning regression models are trained and tested for heat flux prediction. All of the models used data from the transient boiling test with the pH10 Cu foam. One model was a multilayer perceptron (MLP) and used segmented clips of the hydrophone signal converted to frequency intensities using the fast Fourier transform (FFT) to predict heat flux. Another model used only images reduced to 50×50 pixels from a pool boiling experiment. It coupled convolutional layers for feature extraction with an MLP for regression. The third model (“image and acoustic fusion model”), which is shown in FIG. 10, used both image data and acoustic signals.

Referring to FIG. 10, FIG. 10 illustrates a schematic drawing of the image and acoustic fusion model in accordance with an embodiment of the present disclosure.

As illustrated in FIG. 10, features 1001 extracted from images 1002 using CNN are flattened and concatenated with features 1003 extracted from acoustics 1004 using FFT as illustrated by element 1005. The concatenated features 1005 are then passed through an MLP for heat flux prediction 1006.

In one embodiment, feature extraction is performed on both data types (e.g., FFT for audio and convolutional layers for images) and concatenated together and passed through an MLP for heat flux prediction. In an experiment, all three of the models discussed above used the same MLP structure for prediction. For the results of these models, the hydrophone signal was split into non-overlapping sequences of a length of 3,000 samples. Each of the sequences is mapped to an image and corresponding heat flux. For all the models, 80% of the data is used for training and 20% for testing. In one embodiment, each model is trained with the Adam optimizer and a mean squared error loss function. In one embodiment, the FFT feature extraction is implemented using NumPy® and the models are implemented using TensorFlow®.

In one embodiment, both the acoustic (from hydrophone) and optical data are combined to predict the heat flux. After training all three regression models, the coefficient of determination (R² score) results are shown in FIG. 11.

Referring to FIG. 11, FIG. 11 illustrates the R² scores (coefficient of determination scores) for the three machine learning models, including the image CNN-MLP, sound FFT-MLP, and image-sound fusion model in accordance with an embodiment of the present disclosure.

The R² score is a measurement of the fit of the model to the data. Values close to 1 are desired and indicate a good fit. As illustrated in FIG. 11, the image regression model performed the worst with an R² score of 0.68, which may be due to the reduced image size and small training set. Furthermore, as illustrated in FIG. 11, the fusion model did the best with an R² score of 0.941, which is better than the sound model with an R² score of 0.928. Hence, by incorporating both image data and sound data in a fusion model, there is an improvement in the accuracy. This can be attributed to different approaches, whether it be optical or acoustic data acquisition, implemented in the very same boiling process. The method for procuring the images and sounds would be independent of themselves but they correspond to the same physical phenomenon. As a result, a fusion of both optic-acoustic models shows great promise in the effective prediction of heat fluxes.

A discussion regarding microphone-hydrophone data fusion for heat flux prediction is now provided below.

In one embodiment, two different machine learning regression model architectures are used; multilayer perceptron (MLP) and Gaussian process regression. For each model architecture type, two of the models are trained using only hydrophone or only microphone data and the remaining models used a combination of both types of data in fusion models. For all the models, 80% of the data is used for training while 20% is used for testing. For the MLP models, 20% of the training data is used for validation. All of the models used the same training data and testing data.

In one embodiment, four different MLP model architectures are trained and tested on the hydrophone and microphone data separately. The architecture which had the best performance on the test data for both the hydrophone and microphone data was chosen for further analysis and for use in the feature extraction portion of the fusion models.

An MLP is a machine learning model that consists of layers of neurons. Each neuron describes a function whose inputs are first each multiplied by a weight then summed with a bias and passed through an activation function. A common activation function is the rectified linear unit (ReLU) which is defined as f(x)=max (0, x). During training, backpropagation is used to iteratively update the weights and biases to minimize the specified loss. In supervised learning, the loss function is defined to describe the difference between the model's prediction and true label. For example, the mean squared error loss function is commonly used in regression problems and defined as

$$MSE = \frac{1}{N} {\sum }_{i = 1}^{N} {( {true}_{i} - {pred}_{i} )}^{2} .$$

In one embodiment, the models consisted of 6 dense layers with 200, 200, 200, 200, 64, and 1 neurons, respectively. The first 5 layers used the ReLU activation function. Dropout after the 2^{nd}, 4^{th}, and 6^{th} layer is implemented with a rate of 0.2. Dropout is used to prevent overfitting during training by randomly dropping inputs at a specified rate for the layer.

In one embodiment, three types of fusion are implemented on the data: early, joint, and late. FIG. 12 illustrates the general structure of the three types of fusion models used, namely, early fusion 1201, joint fusion 1202 and late fusion 1203, in accordance with an embodiment of the present disclosure.

Referring to FIG. 12, in one embodiment, fusion models (1201, 1202, 1203) all took in inputs of both hydrophone and microphone frequency features.

In one embodiment, early fusion model 1201 concatenated the hydrophone and microphone frequency features 1204, 1205 into element 1206, where the concatenated features 1206 is passed through an MLP for heat flux prediction 1207. In one embodiment, the MLP consists of 6 dense layers with 200, 200, 200, 200, 64, and 1 neurons. The first 5 layers used the ReLU activation function. Two dropout layers with a rate of 0.2 are applied after the 2^{nd} and 4^{th} layer.

For joint fusion model 1202, the hydrophone and microphone frequency features 1208, 1209, respectively, are passed through MLPs 1210 separately. In one embodiment, MLPs 1210 consists of 2 dense layers with 200 and 200 neurons, ReLU activation functions, and 0.2 dropout after the second layer. The output of these two MLPs 1210 is then concatenated (see 1211) and this vector is then passed through a MLP for heat flux prediction 1212, where the MLP consists of 4 layers with 128, 128, 64, and 1 neurons. In one embodiment, the first 3 layers of MLP had an ReLU activation function, and the 2^{nd} layer had 0.2 dropout applied.

In one embodiment, late fusion model 1203 consists of two identical MLPs 1213, 1214 for the hydrophone and microphone frequency feature vectors 1215, 1216, respectively. In one embodiment, models 1213, 1214 had 5 layers with 200, 200, 200, 200, and 64 neurons, all with ReLU activation functions. A dropout layer with a rate of 0.2 is applied after the 2^{nd} and 4^{th} layer. The output of these MLPs are concatenated (see 1217) and then passed through a single dense layer with one neuron in order to perform heat flux prediction 1218.

In one embodiment, all of the models used the mean squared error loss function and the Adam optimizer. They are trained with a patience of 10 and the weights corresponding to the best validation loss were restored. In one embodiment, these five machine learning model structures are implemented using TensorFlow®.

Gaussian process regression (GPR), another supervised machine learning regression model architecture, may also be implemented. Gaussian process regression is a probabilistic model in which a kernel is defined and used for calculating the covariance matrix used in fitting the data. Three different Gaussian models were trained; one using only the hydrophone frequency intensity data, one using only microphone frequency intensity data, and one used both data types. All three models used the same kernel: DotProduct( )+ WhiteKernel( )+ ConstantKernel( ).

where

$$DotProduct : k ( {x}_{i} , {x}_{j} ) = {σ}_{0}^{2} + {x}_{i} \cdot {x}_{j} ;$$

$$WhiteKernel : k ( {x}_{i} , {x}_{j} ) = \{ \begin{matrix}1 & i f {x}_{i} == {x}_{j} \\ & 0\end{matrix} ;$$

$$ConstantKernel : k ( {x}_{i} , {x}_{j} ) = 1. .$$

In one embodiment, for the combined model, the microphone and hydrophone frequency features for each corresponding heat flux are appended together. This model is referred to herein as the “early fusion Gaussian model.” In one embodiment, these models are implemented using the Scikit-learn® library in Python®.

Five different supervised MLP models are trained. One MLP for hydrophone data only, one MLP for microphone data only and three fusion models combining both data types for predicting heat flux. For all the model types using microphone data, both the filtered and raw signals are used for training and testing. FIG. 13 shows the coefficient of determination (R² score) for the models calculated from the test data in accordance with an embodiment of the present disclosure.

The R² score is defined as

$${R}^{2} = 1 - \frac{{\sum }_{i = 1}^{N} {( {True}_{i} - {Pred}_{i} )}^{2}}{{\sum }_{i = 1}^{N} {( {True}_{i} - Mean )}^{2}} .$$

This is a measurement of the fit of the model to the data, where an R² of 1 is the best scenario and values close to one are desired indicating the model fits the data well. As illustrated in FIG. 13, the model just using the hydrophone data performs better than the models just using the microphone signals. It is also observed that the MLP model with the filtered microphone data performs worst when trained and tested with raw signal data than the filtered data. However, this is not the case for the three fusion models. For the joint and late fusion types, the model using filtered microphone data performed better than the one with the raw signal. It is also seen that with the exception of the noisy early fusion model, all the fusion models preform better than the non-fused models. For the raw microphone data, the best model was found to be the late fusion model achieving a R² score of 0.982 on the test data. While the best model using the filtered microphone signal was found to be the late fusion model with a R² score of 0.985.

Furthermore, in one embodiment, three Gaussian process regression models are also trained and tested using the same data. FIG. 14 shows the R² score for the three GPR models in accordance with an embodiment of the present disclosure. As illustrated in FIG. 14, the noise filtering performed on the microphone data did not improve the performance for either of the models including microphone data. The early fusion model using the noisy microphone data performed the best with an R² score of 0.985. This value was the highest achieved among all of the models including the MLP ones. However, when compared to the MLP models, both the hydrophone data only and microphone data only GPR models had lower R² scores.

Additional details regarding detecting or predicting critical heat flux in cooling systems during pool boiling in a non-intrusive manner are found in U.S. Provisional Patent Application Ser. No. 63/434,137 entitled “Detecting or Predicting Critical Heat Flux in Cooling Systems During Pool Boiling in a Non-Intrusive Manner Using Acoustic Emissions,” filed on Dec. 21, 2022, which is incorporated by reference herein in its entirety. Additional details regarding detecting or predicting critical heat flux in cooling systems during pool boiling in a non-intrusive manner may also be found in Dunlap et al., “Nonintrusive Heat Flux Quantification Using Acoustic Emissions During Pool Boiling,” Applied Thermal Engineering, Vol. 228, 2023, pp. 1-11; Pandey et al., “Multimodal Characterization of Steady-State and Transient Boiling Heat Transfer,” Proceedings of the ASME 2023 Heat Transfer Summer Conference, Washington D.C., Jul. 10-12, 2023, pp. 1-10; and Dunlap et al., “Remote Thermal Measurements with Regression of Acoustic Emissions,” Proceedings of the ASME 2023 Heat Transfer Summer Conference, Washington D.C., Jul. 10-12, 2023, pp. 1-9, which are all incorporated by reference herein in their entirety.

In this manner, the embodiments of the present disclosure provide a means for effectively detecting or predicting critical heat flux in cooling systems (thermal management systems) during pool boiling in a non-intrusive manner.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for detecting or predicting critical heat flux in cooling systems, the method comprising:
building and training a model to detect or predict an occurrence of critical heat flux in a cooling system based on acoustic signals in a frequency domain;
receiving acoustic signals from one or more sensors remotely located from said cooling system in a temporal domain;
converting said acoustic signals from said temporal domain to a frequency domain; and
detecting or predicting said occurrence of said critical heat flux in said cooling system using said trained model based on said acoustic signals in said frequency domain.

2. The method as recited in claim 1 further comprising:
implementing a remedial or a preventive measure based on said detected or predicted occurrence of said critical heat flux.

3. The method as recited in claim 2, wherein said cooling system is utilized to remove and dissipate heat from a device, wherein said remedial measure comprises cooling said device, wherein said preventive measure comprises preventing overheating or overcooling of said device.

4. The method as recited in claim 1, wherein said acoustic signals in said temporal domain are in a form of sound pressure, wherein said acoustic signals in said temporal domain are received from one or more acoustic emission sensors, one or more hydrophones and/or one or more microphones.

5. The method as recited in claim 1, wherein said acoustic signals in said frequency domain are in a form of a spectrogram or in a form of a power spectrum.

6. The method as recited in claim 5, wherein features are extracted from said power spectrum and utilized by said trained model to detect or predict said critical heat flux in said cooling system.

7. The method as recited in claim 5, wherein features are extracted from said spectrogram using an artificial neural network and utilized by said trained model to detect or predict said critical heat flux in said cooling system.

8. The method as recited in claim 7, wherein said artificial neural network comprises a convolutional neural network.

9. A computer program product for detecting or predicting heat flux measurements in cooling systems, the computer program product comprising one or more computer readable storage mediums having program code embodied therewith, the program code comprising programming instructions for:
building and training a model to detect or predict an occurrence of critical heat flux in a cooling system based on acoustic signals in a frequency domain;
receiving acoustic signals from one or more sensors remotely located from said cooling system in a temporal domain;
converting said acoustic signals from said temporal domain to a frequency domain; and
detecting or predicting said occurrence of said critical heat flux in said cooling system using said trained model based on said acoustic signals in said frequency domain.

10. The computer program product as recited in claim 9, wherein the program code further comprises the programming instructions for:
implementing a remedial or a preventive measure based on said detected or predicted occurrence of said critical heat flux.

11. The computer program product as recited in claim 10, wherein said cooling system is utilized to remove and dissipate heat from a device, wherein said remedial measure comprises cooling said device, wherein said preventive measure comprises preventing overheating or overcooling of said device.

12. The computer program product as recited in claim 9, wherein said acoustic signals in said temporal domain are in a form of sound pressure, wherein said acoustic signals in said temporal domain are received from one or more acoustic emission sensors, one or more hydrophones and/or one or more microphones.

13. The computer program product as recited in claim 9, wherein said acoustic signals in said frequency domain are in a form of a spectrogram or in a form of a power spectrum.

14. The computer program product as recited in claim 13, wherein features are extracted from said power spectrum and utilized by said trained model to detect or predict said critical heat flux in said cooling system.

15. The computer program product as recited in claim 13, wherein features are extracted from said spectrogram using an artificial neural network and utilized by said trained model to detect or predict said critical heat flux in said cooling system.

16. The computer program product as recited in claim 15, wherein said artificial neural network comprises a convolutional neural network.

17. A system, comprising:
a memory for storing a computer program for detecting or predicting heat flux measurements in cooling systems; and
a processor connected to said memory, wherein said processor is configured to execute program instructions of the computer program comprising:
building and training a model to detect or predict an occurrence of critical heat flux in a cooling system based on acoustic signals in a frequency domain;
receiving acoustic signals from one or more sensors remotely located from said cooling system in a temporal domain;
converting said acoustic signals from said temporal domain to a frequency domain;
and detecting or predicting said occurrence of said critical heat flux in said cooling system using said trained model based on said acoustic signals in said frequency domain.

18. The system as recited in claim 17, wherein the program instructions of the computer program further comprise:
implementing a remedial or a preventive measure based on said detected or predicted occurrence of said critical heat flux.

19. The system as recited in claim 18, wherein said cooling system is utilized to remove and dissipate heat from a device, wherein said remedial measure comprises cooling said device, wherein said preventive measure comprises preventing overheating or overcooling of said device.

20. The system as recited in claim 17, wherein said acoustic signals in said temporal domain are in a form of sound pressure, wherein said acoustic signals in said temporal domain are received from one or more acoustic emission sensors, one or more hydrophones and/or one or more microphones.

21. The system as recited in claim 17, wherein said acoustic signals in said frequency domain are in a form of a spectrogram or in a form of a power spectrum.

22. The system as recited in claim 21, wherein features are extracted from said power spectrum and utilized by said trained model to detect or predict said critical heat flux in said cooling system.

23. The system as recited in claim 21, wherein features are extracted from said spectrogram using an artificial neural network and utilized by said trained model to detect or predict said critical heat flux in said cooling system.

24. The system as recited in claim 23, wherein said artificial neural network comprises a convolutional neural network.

25. A computer-implemented method for detecting or predicting critical heat flux in cooling systems, the method comprising:
extracting a first set of features from image data of a cooling system using a neural network;
extracting a second set of features from acoustic data of said cooling system using a fast Fourier transform;
concatenating said first set of features and said second of features; and
detecting or predicting an occurrence of said critical heat flux in said cooling system by a machine learning regression model using said concatenated features.

26. The method as recited in claim 25, wherein said machine learning regression model comprises a multi-layer neural network.

27. The method as recited in claim 25, wherein said first and second sets of features are passed through two or more machine learning regression models separately, wherein an output of said two or more machine learning regression models is concatenated.

28. The method as recited in claim 25, wherein said first and second sets of features are passed through two or more machine learning regression model separately, wherein an output of said two or more machine learning regression models is concatenated and passed through a single dense layer with one neuron.

29. The method as recited in claim 25 further comprising:
passing said concatenated features through said machine learning regression model for critical heat flux prediction after concatenating said first set of features and said second of features.

30. The method as recited in claim 25, wherein said image data is acquired from a camera.

31. The method as recited in claim 25, wherein said acoustic data is acquired from a hydrophone and/or a microphone.

32. A computer program product for detecting or predicting heat flux measurements in cooling systems, the computer program product comprising one or more computer readable storage mediums having program code embodied therewith, the program code comprising programming instructions for:
extracting a first set of features from image data of a cooling system using a neural network;
extracting a second set of features from acoustic data of said cooling system using a fast Fourier transform;
concatenating said first set of features and said second of features; and
detecting or predicting an occurrence of said critical heat flux in said cooling system by a machine learning regression model using said concatenated features.

33. The computer program product as recited in claim 32, wherein said machine learning regression model comprises a multi-layer neural network.

34. The computer program product as recited in claim 32, wherein said first and second sets of features are passed through two or more machine learning regression models separately, wherein an output of said two or more machine learning regression models is concatenated.

35. The computer program product as recited in claim 32, wherein said first and second sets of features are passed through two or more machine learning regression model separately, wherein an output of said two or more machine learning regression models is concatenated and passed through a single dense layer with one neuron.

36. The computer program product as recited in claim 32, wherein the program code further comprises the programming instructions for:
passing said concatenated features through said machine learning regression model for critical heat flux prediction after concatenating said first set of features and said second of features.

37. The computer program product as recited in claim 32, wherein said image data is acquired from a camera.

38. The computer program product as recited in claim 32, wherein said acoustic data is acquired from a hydrophone and/or a microphone.

39. A system, comprising:
a memory for storing a computer program for detecting or predicting heat flux measurements in cooling systems; and
a processor connected to said memory, wherein said processor is configured to execute program instructions of the computer program comprising:
extracting a first set of features from image data of a cooling system using a neural network;
extracting a second set of features from acoustic data of said cooling system using a fast Fourier transform;
concatenating said first set of features and said second of features; and
detecting or predicting an occurrence of said critical heat flux in said cooling system by a machine learning regression model using said concatenated features.

40. The system as recited in claim 39, wherein said machine learning regression model comprises a multi-layer neural network.

41. The system as recited in claim 39, wherein said first and second sets of features are passed through two or more machine learning regression models separately, wherein an output of said two or more machine learning regression models is concatenated.

42. The system as recited in claim 39, wherein said first and second sets of features are passed through two or more machine learning regression model separately, wherein an output of said two or more machine learning regression models is concatenated and passed through a single dense layer with one neuron.

43. The system as recited in claim 39, wherein the program instructions of the computer program further comprise:
passing said concatenated features through said machine learning regression model for critical heat flux prediction after concatenating said first set of features and said second of features.

44. The system as recited in claim 39, wherein said image data is acquired from a camera.

45. The system as recited in claim 39, wherein said acoustic data is acquired from a hydrophone and/or a microphone.
